(19) United States
(12) Patent Application Publication
(10) Pub. No.: US 2022/0337787 A1
(43) Pub. Date: Oct. 20, 2022

(54) WIRELESS DEVICE AND IMAGE SURVEILLANCE DEVICE HAVING MULTI-STATION MODE, AND WIRELESS COMMUNICATION SYSTEM

(71) Applicant: Mars Semiconductor Corp., Hsinchu City (TW)

(72) Inventors: Yi-Shing Chang, Hsinchu City (TW); Luen-Sheng Yuan, Hsinchu City (TW)

(21) Appl. No.: 17/233,095

(22) Filed: Apr. 16, 2021

(51) Int. Cl. H04N 7/18; H04W 76/16

(52) U.S. Cl. CPC H04N 7/183; H04W 76/16; H04W 88/10

(57) ABSTRACT

A wireless device having a multi-station mode provided by the present disclosure can act as a client/station. The wireless device has at least one wireless communication transceiver circuit. The wireless communication transceiver circuit makes the wireless device operate in the multi-station mode to link to multiple access point devices of hosts/APs simultaneously, and that is, the wireless device can be used as a work station of the access point devices of hosts/APs. The wireless device of the present disclosure can act as the work station of the access point devices at the same time or in the time-sharing manner, so it solves the technical problem that multiple transmitter devices of WLAN in the prior art cannot be used as the work station of the receiver device and the wireless network router (that is, the technical problem that each of multiple transmitter devices can only link to one access point).

### BACKGROUND

### Technical Field

The present disclosure relates to a wireless data communication technology, and mainly relates to a wireless device with a multi-station mode, an image monitoring device with a multi-station mode and a wireless communication system using the same.

### Related Art

Wi-Fi is a technology that can wirelessly connect personal computers, handheld devices (such as pads, mobile phones) and other terminals to each other. In fact, it utilizes a high-frequency radio signal. Wi-Fi is the abbreviation of Wireless-Fidelity, which is one of the technologies for realizing Wireless Local Area Network (WLAN). At present, most Wi-Fi WLANs adopt the IEEE 802.11 standard protocol set, and especially physical layers and a medium access control layers of Wi-Fi WLANs completely use the IEEE 802.11 standard protocol set.

Refer to FIG. 1, and FIG. 1 is a schematic diagram showing a conventional wireless device or image surveillance device which is applied in a WLAN. In FIG. 1, the wireless communication system 1 acting as a WLAN comprises transmitter devices 101, 102, a wireless network router 11 and a receiver device 12. The transmitter devices 101 and 102 can be conventional wireless devices or image surveillance devices. For example, the transmitter devices 101 and 102 can be media casting devices, webcams, baby monitoring devices or surveillance devices, and types of the transmitter devices 101 and 102 may not be limited. The wireless network router 11 can be a Wi-Fi router, and the type of the wireless network router 11 may not be limited. The receiver device 12 can be a network drive or other electronic devices, and the type of the receiver device 12 may not be limited.

The transmitter device 101 operates in a access point plus work station mode (AP+Mode), and that is, the transmitter device 101 operates in a concurrent mode of an access point (AP) mode and a station mode. The transmitter device 101 acts as an AP device of the receiver device 12 (i.e. the receiver device 12 operates in the station mode), and the transmitter device 101 acts as a work station of the wireless network router 11. Thus, the transmitter device 101 can transmit data to the receiver device 12 and the wireless network router 11.

The wireless network router 11 links to a remote smart phone 13 via a wireless communication (such as, Wi-Fi, Wi-Max, 4G or 5G), such that, the smart phone 13 can obtain data transmitted from the transmitter device 101 via the wireless network router 11. For example, the user can watch the surveillance images obtained by the transmitter device 101 through the smart phone 13 at the remote end. The other transmitter device 102 can be used as a work station of the wireless router 11 (that is, the transmitter device 102 operates in the station mode). However, since the transmitter device 102 has been used as the work station of the wireless router 11, the transmitter device 102 can no longer be used as the work station of the receiver device 12 (that is, the receiver device 12 cannot be used as the access point device of the transmitter device 102), resulting in the transmitter device 102 being unable to send data to the receiver device 12. Simply put, in the architecture of wireless communication system 1, the receiver device 12 can only act as the work station of the transmitter device 101, that is, merely the transmitter device 101 can link to the receiver device 12 and send data to the receiver device 12.

When the transmitter device 101 and 102 are two image surveillance devices, and the receiver device 12 is a network drive, only the surveillance images obtained by the transmitter device 101 are stored in the network drive. In this way, when an unexpected situation or event occurs and the surveillance image needs to be viewed afterwards, the surveillance image obtained by the transmitter device 101 can only be checked through the receiver device 12 as a network drive, but the surveillance image obtained by the transmitter device 102 cannot be checked through the receiver device 12. Although, an additional receiver device can be deployed to make the transmitter device 102 operate in the access point plus station mode (AP+Mode), which can solve the above technical problems, this manner makes an increase in the construction cost.

### SUMMARY

An objective of the present disclosure is to provide a wireless device having a multi-station mode which can act as a client/station. The wireless device comprises at least one wireless communication transceiver circuit. The wireless communication transceiver circuit makes the wireless device operate in the multi-station mode to link to multiple (two or more than two) access point devices of hosts/APs simultaneously, and that is, the wireless device can be used as a work station of the access point devices.

In addition, an objective of the present disclosure is to provide an image surveillance device using the wireless device, and to provide a wireless communication system comprising the wireless devices with the multi-station mode.

In summary, the wireless device of the present disclosure can be used as a work station for multiple access point devices at the same time or in a time-sharing manner (i.e., the wireless device is linked to multiple access point devices at the same time), so it solves the technical problem that the transmitter device of the WLAN in prior art cannot be used as the work station of the receiver device and the wireless network router (that is, the technical problem is that each of the multiple transmitter devices can only link to one access point). In this way, the beneficial technical effect of the present disclosure is that multiple access point devices can be shared by multiple wireless devices in the wireless communication system at the same time, thereby reducing the construction cost.

### DESCRIPTIONS OF DRAWINGS

FIG. 1 is a schematic diagram showing a conventional wireless device or image surveillance device which is applied in a WLAN.

FIG. 2 is a schematic diagram showing a wireless device or image surveillance device having a multi-station mode which is applied in a WLAN according to an embodiment of the present disclosure.

FIG. 3 is a block diagram showing a wireless device or image surveillance device having a multi-station mode according to an embodiment of the present disclosure.

FIG. 4 is a timing chart of data transmission of a transmitter device having a multi-station mode according to an embodiment of the present disclosure.

FIG. 5 is a timing chart of data transmission of a transmitter device having a multi-station mode according to another one embodiment of the present disclosure.

FIG. 6 is a timing chart of data transmission of a transmitter device having a multi-station mode according to another one embodiment of the present disclosure.

FIG. 7 is a spectrum chart of data transmission of a transmitter device having a multi-station mode according to another one embodiment of the present disclosure.

FIG. 8 is a flow chart showing a WLAN formation by transmitter devices having a multi-station mode, a receiver device and a wireless network router according to one embodiment of the present disclosure.

FIGS. 9A-9C are schematic diagrams showing a wireless device or image surveillance device having a multi-station mode operates in a concurrent mode according to an embodiment of the present disclosure.

### DESCRIPTIONS OF EMBODIMENTS

Embodiments of the present disclosure will now be described, by way of example only, with reference to the accompanying drawings. The following drawings are dedicated for description, and they are schematic and exemplary, being not drawn and precisely allocated in accordance with the actual ratio, thus not limiting the present disclosure.

The present disclosure provides an embodiment of a wireless device or image surveillance device having a multi-station mode, and the wireless device or image surveillance device can act as a work station of two or more than two devices or apparatuses (i.e. different access point devices). Preferably, the wireless device or the image surveillance device itself has at least one wireless communication transceiver circuit for implementing operation of the multi-station mode. Furthermore, a wireless device or image surveillance device can act as a transmitter device, and the receiver device and a wireless network router in the wireless communication system of WLAN act as two different access point devices, each of the two or more transmitter devices can act as the work station of the receiver device, and at the same time or in a time-sharing manner as the work station of the wireless network router (that is, a transmitter device can be linked two or more access point devices at the same time). In this way, the receiver device can obtain the data transmitted by each transmitter device, and the remote smart phone or other electronic device can link to the wireless network router, and obtain the data transmitted by each transmitter device through the wireless network router.

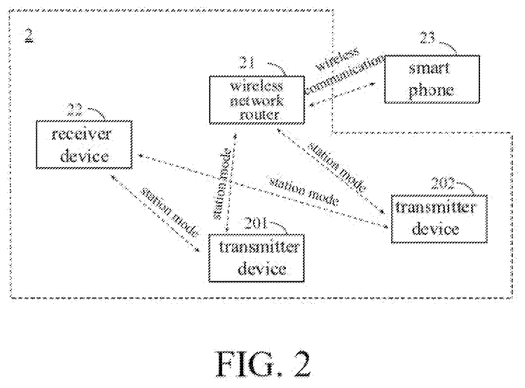

Refer to FIG. 2, and FIG. 2 is a schematic diagram showing a wireless device or image surveillance device having a multi-station mode which is applied in a WLAN according to an embodiment of the present disclosure. The wireless communication system 2 of WLAN comprises transmitter devices 201, 102, a wireless network router 21 and a receiver device 22. The wireless devices or image surveillance devices having a multi-station mode are respectively the transmitter devices 201 and 202, and the transmitter devices 201 and 202 can be media casting devices, webcams, baby monitoring devices or surveillance devices, and types of the transmitter devices 201 and 202 are not limited. The wireless network router 21 can be a Wi-Fi router, and the type of the wireless network router 11 is not limited. The receiver device 22 can be a network drive or other electronic devices, and the type of the receiver device 22 is not limited.

Each of the transmitter devices 201 and 202 can be operated in the multi-station mode, that is, can be used as the client/station (client/station) of the access point devices of two or more devices or apparatuses at the same time or in a time-sharing manner. Specifically, each of the transmitter devices 201 and 202 serves as the work station of the receiver device 22 and the wireless network router 21 at the same time or in time-sharing manner (that is, the transmitter devices 201 and 202 can link to two or more access point devices at the same time). In this way, each of the transmitter devices 201 and 202 can transmit data to the receiver device 22 and the wireless network router 21.

The wireless network router 21 links to the remote smart phone 23 through wireless communication (for example, Wi-Fi, Wi-Max, 4G, or 5G, but not limited by these). The smart phone 23 can be replaced with electronic devices of other types, such as a tablet computer or a notebook computer, and the present disclosure is not limited. The smart phone 23 can act as a part of the wireless communication system 2 by linking to the wireless network router 21. The smart phone 23 can obtain the data transmitted by the transmitter devices 201 and 202 through the wireless network router 21. For example, the user can watch the surveillance images obtained by the transmitter devices 201 and 202 through the smart phone 23 remotely. In addition, through the multi-station mode, the receiver device 22 can be used as the access point device of the host/AP (host/AP) of the transmitter devices 201 and 202, so the data transmitted by the transmitter devices 201 and 202 can be obtained by the receiver device 22.

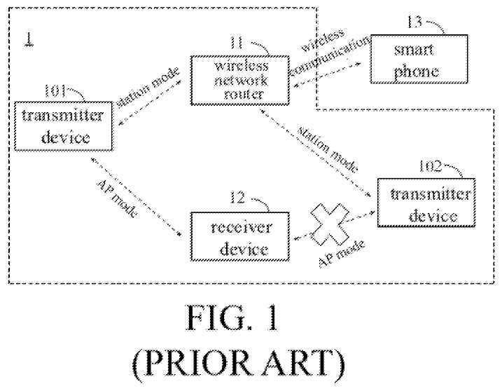

It can be seen that the present disclosure improves the technical problem of the prior art (refer to FIG. 1, the receiver device 11 can only receive the data transmitted by the transmitter device 101). In this way, when an unexpected situation or event occurs and the surveillance images need to be viewed afterwards, the surveillance images obtained by both the transmitter device 201 and 202 can be checked through the receiver device 22 as a network drive (assuming that the transmitter devices 201 and 202 are webcams, surveillance devices or baby monitoring devices).

Then, how to make the transmitter devices 201 and 202 can operate in multi-station mode is further explained. Without considering the hardware cost, each of the transmitter devices 201 and 202 has two wireless communication transceiver circuits, one wireless communication transceiver circuit is used to link to the receiver device 22, and the other wireless communication transceiver circuit is used to link to the wireless network router 21, wherein the two wireless communication transceiver circuits use different frequency bands, time slots and/or different orthogonal codes (for example, Walsh codes), and the present disclosure is not limited. The different orthogonal codes can be applied to the transmitted data by adding physical layer hardware circuit or executing software above the network layer, and therefore, it avoids collisions when two wireless communication transceiver circuits transmit data.

For example, each of the transmitter devices 201 and 202 uses Wi-Fi or IEEE 802.11 to link to the wireless network router 21 and the receiver device 22, and serves as a work station for both the wireless network router 21 and the receiver device 22. One wireless communication transceiver circuit of the transmitter device 201 is allowed to transmit data to the wireless network router 21 in the first time slot (time slot T_{1+4*K}, where K is a non-negative integer, that is, an integer greater than or equal to 0). The other one wireless communication transceiver circuit of the transmitter device 201 is allowed to transmit data to the receiver device 22 in the second time slot (time slot T_{2+4*K}, where K is a non-negative integer, that is, an integer greater than or equal to 0). One wireless communication transceiver circuit of the transmitter device 202 is allowed to transmit data to the wireless network router 21 in the third time slot (time slot T_{3+4*K}, where K is a non-negative integer, that is, an integer greater than or equal to 0). The other one wireless communication transceiver circuit of the transmitter device 202 is allowed to transmit data to the receiver device 22 in the fourth time slot (time slot T_{4+4*K}, where K is a non-negative integer, that is, an integer greater than or equal to 0). It is noted that, there are two modes for Wi-Fi or IEEE 802.11 to solve data collisions. One is to allocate time slots by a time slot configuration, and other one is to perform carrier sense multiple access with collision detection (CSMA/CA), and the above example can be implemented by the time slot configuration.

In another one embodiment, one wireless communication transceiver circuit of each of the transmitter devices 201 and 202 is allowed to transmit data to the receiver device 22 in the first time slot T_{1+2*K}, and other one wireless communication transceiver circuit of each of the transmitter devices 201 and 202 is allowed to transmit data to the receiver device 22 in the second time slot T_{2+2*K}. The embodiment adopts CSMA/CA, when detecting collision, the transmitter device 201 or 202 will randomly delay to re-transmit data in the next time slot which the data transmission is allowed. Since each of the transmitter devices 201 and 202 has two wireless communication transceiver circuits, regardless the better transmission efficiency, the time slot configuration may be not necessary, and merely CSMA/CA is adopted.

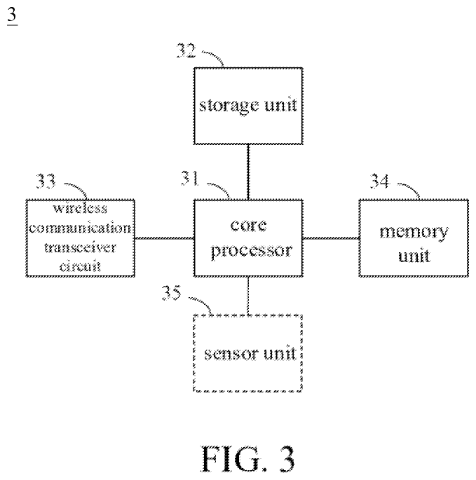

In the above embodiment, each transmitter device uses two wireless communication transceiver circuits to implement the multi-station mode, but the present disclosure is not limited. Another approach is to utilize merely one wireless communication transceiver circuit to implement the multi-station mode. The detailed descriptions are as follows. Please refer to FIG. 3, which is a block diagram of a wireless device or image surveillance device with a multi-station mode according to an embodiment of the present disclosure. In FIG. 3, the wireless device or image surveillance device is used as a transmitter device 3, and the transmitter device 3 includes a core processor 31, a storage unit 32, a wireless communication transceiver circuit 33, a memory unit 34, and a sensor unit 35 (the sensor unit 35 is not a necessary component of wireless device, but is the necessary component of the image surveillance device, and at this time is the image sensor).

The core processor 31 is electrically connected to the storage unit 32, the wireless communication transceiver circuit 33, the memory unit 34 and the sensor unit 35. The core processor 31 is used to control the storage unit 32, the wireless communication transceiver circuit 33, the memory unit 34 and the sensor unit 35 to activate and perform calculation process. The storage unit 32 stores program codes for the core processor 31 to read the program codes for control and calculation processing, and the storage unit 32 can also be used to store data. The wireless communication transceiver circuit 33 is used to link to the receiver device and the wireless network router, and can make the transmitter device 3 operate in multi-station mode. The memory unit 34 is used to cache data so that the core processor 31 can access the cached data. The sensor unit 35 is used for sensing the environment to obtain data corresponding to the sensing result, and the data of the sensing result will be sent to the receiver device and the wireless network router.

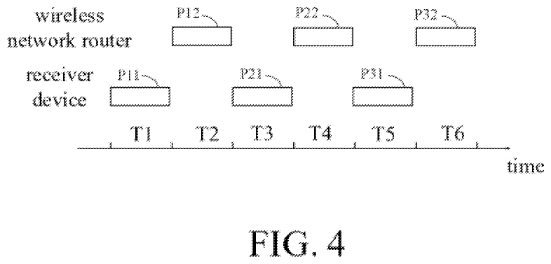

Next, refer to FIG. 4, and FIG. 4 is a timing chart of data transmission of a transmitter device having a multi-station mode according to an embodiment of the present disclosure. In the embodiment of FIG. 4, the transmitter device with only one wireless communication transceiver circuit can be used as a work station of the receiver device and the wireless network router in a time-sharing manner. When there is only one transmitter device in the wireless communication system of WLAN, the transmitter device transmits data P11, P21, and P31 to the wireless network router respectively in time slots T1, T3, and T5, and transmits data P12, P22, P32 to the receiver device respectively in time slots T2, T4, and T6.

When there are multiple transmitter devices in the wireless communication system of WLAN, and it assumes that there are three transmitter devices in FIG. 4, the three transmitter devices are allowed to transmit data P11, P21, and P31 in time slots T1, T3, and T5 to the wireless network router, respectively, and the three transmitter devices are allowed to transmit data P12, P22, and P32 to the receiver device in time slots T2, T4, and T6, respectively. Or alternatively, the three transmitter devices in time slots T1, T3, and T5 can all try to transmit data P11, P21, and P31 to the wireless network router, the three transmitter devices in time slots T2, T4, and T6 can all try to transmit data P12, P22, and P32 to the receiver device, and CSMA/CA is adopted directly to avoid data collisions. If it is detected that data cannot be transmitted, such as data P11, the data P11 will be randomly delayed to be re-transmitted in the next time slot T_{1+2K}.

To put it simply, the above embodiment uses time slot segmentation (i.e. time division multiplexing) to allow the transmitter device with only one wireless communication transceiver circuit to be used as the work station of the receiver device and the wireless network router in a time-sharing manner. The above approach can be achieved by designing new hardware architecture of the wireless communication transceiver circuit; or alternatively, the hardware architecture of the previous wireless communication transceiver circuit is used, and the software control above the network layer is applied to implement the above embodiment.

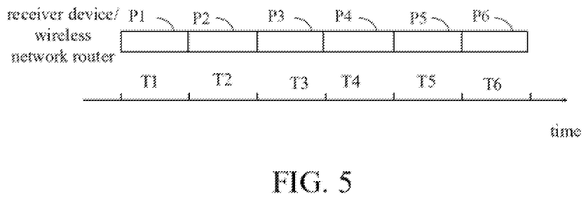

Refer to FIG. 5, and FIG. 5 is a timing chart of data transmission of a transmitter device having a multi-station mode according to another one embodiment of the present disclosure. In the embodiment of FIG. 5, the transmitter device with only one wireless communication transceiver circuit can be used as a work station of the receiver device and the wireless network router at the same time. When there is only one transmitter device in the wireless communication system of WLAN, and the data sent by the transmitter device to the wireless network router is the same as that of the receiver device, the transmitter device can utilize the multicasting or broadcasting mechanism to send data P1-P6 to the wireless network router and the receiver device in time slots T1-T6.

When there are multiple transmitter devices in the wireless communication system of WLAN, suppose there are three transmitter devices, and for each transmitter device, the data sent to the receiver device and the wireless network router are the same, as shown in FIG. 5, the three transmitter devices respectively transmit data P1 to P3 to the wireless network router and receiver device in time slots T1 to T3, and the three transmitter devices transmit data P4 to P6 to the wireless network router and receiver device in time slots T4 to T6, respectively. Or alternatively, the three transmitter devices in time slots T1, T3, and T5 can all try to transmit data P1, P3, and P5 to the wireless network router and receiver device, the three transmitter devices in time slots T2, T4, and T6 can all try to transmit data P2, P4, and P6o the wireless network router and receiver device, and CSMA/CA can be used directly to avoid data collisions. If it is detected that data cannot be transmitted, such as data P1, the data P1 will be randomly delayed to be re-transmitted in time slot T_{1+2K}.

To put it simply, the above embodiment is to use multicasting or broadcasting to make a transmitter device with only one wireless communication transceiver circuit act as a work station for both the receiver device and the wireless network router at the same time. The above approach can be achieved by designing new hardware architecture of the wireless communication transceiver circuit; or alternatively, the hardware architecture of the previous wireless communication transceiver circuit is used, and the software control above the network layer is applied to implement the above embodiment.

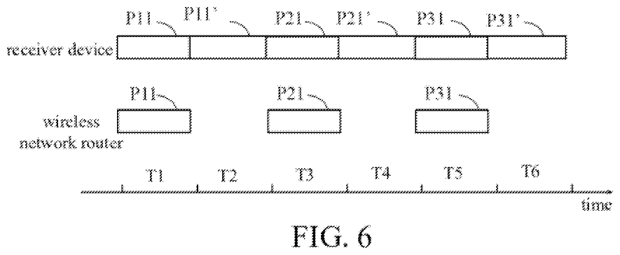

Refer to FIG. 6, and FIG. 6 is a timing chart of data transmission of a transmitter device having a multi-station mode according to another one embodiment of the present disclosure. In the embodiment of FIG. 6, the transmitter device with only one wireless communication transceiver circuit can be used as the work station of the receiver device and the wireless network router at the same time or in a time-sharing manner (partly at the same time). When there is only one transmitter device in the wireless communication system of the wireless local area network, and the data can be divided into basic data and enhanced data, for example, the basic resolution image and high resolution image, the transmitter device which uses the broadcasting or broadcasting mechanism can send data P11, P21 and P31 (basic data) to wireless network router and receiver device respectively in time slots T1, T3 and T5, and send data P11′, P21′ and P31′ (enhanced data) to the receiver device respectively in time slots T2, T4 and T6. Since the remote electronic device which view the image via the wireless network router may have worse network quality than the network quality between the near-end receiver device and transmitter device, the wireless network router only receives data P11, P21, and P31 (basic data).

When there are multiple transmitter devices in the wireless communication system of the wireless local area network, suppose there are three transmitter devices, and the data can be divided into basic data and enhanced data in FIG. 6, the three transmitter devices send data P11, P21, P31 to the wireless network router and receiver device respectively in time slots T1 and T3. , T5, and the three transmitter devices send data P11′, P21′, P31′ to the receiver device in time slots T2, T4, and T6, respectively. Or alternatively, the three transmitter devices in time slots T1, T3, and T5 can all try to transmit data P11, P21, P31 to the wireless network router and receiver device, and the three transmitter devices in time slots T2, T4, and T6 can all try to transmit data P11′, P21′, P31′ to the receiver device, and CSMA/CA can be used directly to avoid data collisions. If it is detected that data cannot be transmitted, such as data P11, the data P11 will be randomly delayed to be re-transmitted in the next time slot T_{1+2K}.

To put it simply, the above embodiment uses multicasting or broadcasting plus time slot segmentation, so that a transmitter device with only one wireless communication transceiver circuit can be used as the work station of the receiver device and the wireless network router at the same time/time sharing. The above approach can be achieved by designing new hardware architecture of the wireless communication transceiver circuit; or alternatively, the hardware architecture of the previous wireless communication transceiver circuit is used, and the software control above the network layer is applied to implement the above embodiment.

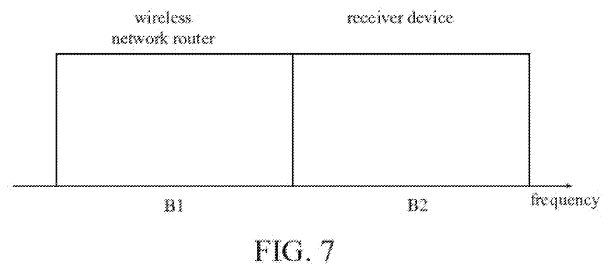

Refer to FIG. 7, and FIG. 7 is a spectrum chart of data transmission of a transmitter device having a multi-station mode according to another one embodiment of the present disclosure. In the embodiment of FIG. 7, the transmitter device with only one wireless communication transceiver circuit can be used as the work station of a receiver device and a wireless network router at the same time. The transmitter device uses a band B1 to link to the wireless network router, and the transmitter device uses a band B2 to link to the receiver device. Therefore, the transmitter device modulates the carriers of the bands B1 and B2 according to the data to be sent to the wireless network router and receiver device. If the transmitter device uses Wi-Fi or IEEE 802.11 protocols, the transmitted wireless signal can be an orthogonal carrier frequency division multiplexing (OFDM) signal. The modulated carriers of the bands B1 and B2 above can form this OFDM signal, and wireless network router and the receiver device can be told to respectively demodulate the signals of the bands B1 and B2.

To put it simply, the above-mentioned embodiment uses band splitting (frequency band division multiplexing) and multicasting (broadcasting) methods to allow the transmitter device with only one wireless communication transceiver circuit to be used as the work station of the receiver device and the wireless network router at the same time. The above approach can be achieved by designing new hardware architecture of the wireless communication transceiver circuit; or alternatively, the hardware architecture of the previous wireless communication transceiver circuit is used, and the software control above the network layer is applied to implement the above embodiment.

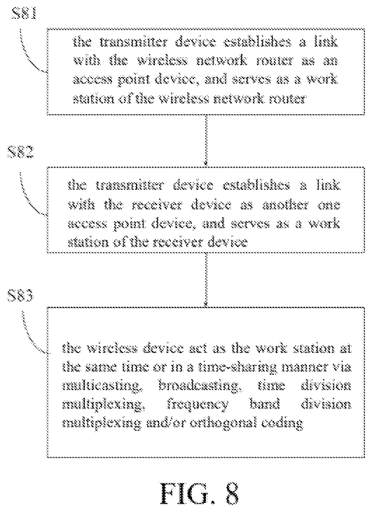

Please refer to FIG. 8, and FIG. 8 is a flow chart showing a WLAN formation by transmitter devices having a multi-station mode, a receiver device and a wireless network router according to one embodiment of the present disclosure. In step S81, the transmitter device establishes a link with the wireless network router as an access point device, and serves as a work station of the wireless network router. In step S82, the transmitter device establishes a link with the receiver device as another one access point device, and serves as a work station of the receiver device. The execution sequence of steps S81 and S82 is not intended to limit the present disclosure. Next, in step S83, the wireless device act as the work station at the same time or in a time-sharing manner via multicasting, broadcasting, time division multiplexing, frequency band division multiplexing and/or orthogonal coding, wherein the details of this step have been explained above, thus omitting the redundant descriptions. By the way, the link between the above-mentioned transmitter device and the wireless network router can be established through the Wi-Fi protocol, and the link between the transmitter device and the receiver device can be established through Proprietary Wi-Fi (P Wi-Fi) protocol, in which the wireless communication transceiver circuit is the Wi-Fi module. Furthermore, the communication protocols used can also be all or none of the standard Wi-Fi protocols, any combination of Wi-Fi protocols and private Wi-Fi protocols. The configuration of the above protocol is not intended to limit the present disclosure. Any method that enables a transmitter device as a client/station to be linked to two or more receiver devices as hosts/APs at the same time is within the scope of the present disclosure. In the embodiment using the combination of Wi-Fi protocol and P Wi-Fi protocol, the multi-station mode refers to a mode in which the transmitter device as a client/station can run Wi-Fi protocols of two different types simultaneously, for example, Wi-Fi protocol and P Wi-Fi protocol. Incidentally, although the above description takes the transmitter device linked to the receiver device and the wireless network router as the access point devices at the same time as an example, in fact, in other applications, the transmitter device can also be linked to multiple wireless network routers as the access points at the same time.

In another one embodiment, the transmitter device can act as an access point device of another transmitter device. For example, a first transmitter device links to a receiver device through the standard Wi-Fi protocol, the first transmitter device can operated in the multi-station or standard concurrent mode. Thus, a second transmitter device links to the first transmitter device through the Proprietary Wi-Fi (P Wi-Fi) protocol or Proprietary RF protocol. Furthermore, the first transmitter device acts as an access point device and links to a third transmitter device as a station through the standard Wi-Fi protocol.

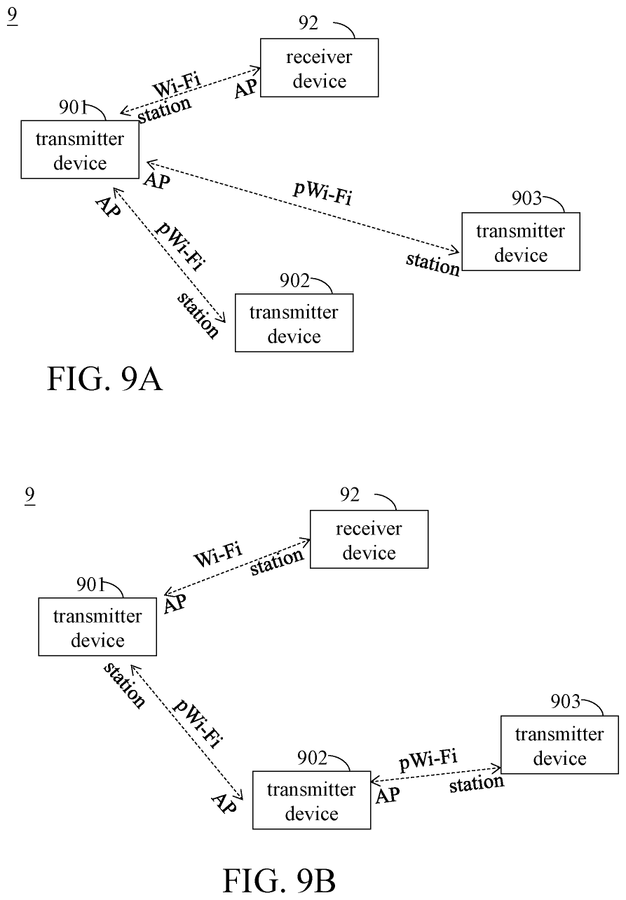

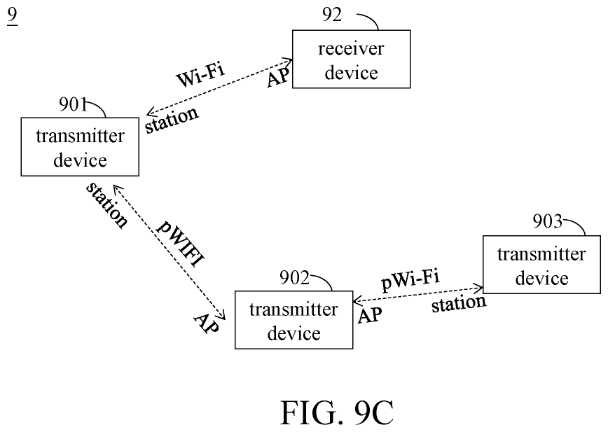

Finally, refer to FIG. 9A, 9B and 9C. FIGS. 9A-9C are schematic diagrams showing a wireless device or image surveillance device having a multi-station mode operates in a concurrent mode according to an embodiment of the present disclosure. The wireless communication system 9 of WLAN comprises transmitter devices 901, 902, 903 and a receiver device 92. In FIG. 9A, the transmitter device 901 operates in a concurrent mode. The transmitter device 901 links to the receiver device 92 through the standard Wi-Fi protocol, the transmitter device 901 acts as a work station and the receiver device 92 acts as an access point. The transmitter device 901 links to the transmitter device 902 through the Proprietary Wi-Fi (P Wi-Fi) protocol, the transmitter device 902 acts as a work station and the transmitter device 901 acts as an access point. The transmitter device 901 links to the transmitter device 903 through the Proprietary Wi-Fi (P Wi-Fi) protocol, the transmitter device 903 acts as a work station and the transmitter device 901 acts as an access point.

In FIG. 9B, the transmitter device 901 operates in a concurrent mode. The transmitter device 901 links to the receiver device 92 through the standard Wi-Fi protocol, the transmitter device 901 acts as an access point and the wireless device 92 acts as a work station. The transmitter device 901 links to the transmitter device 902 through the Proprietary Wi-Fi (P Wi-Fi) protocol, the transmitter device 901 acts as a work station and the transmitter device 902 acts as an access point. The transmitter device 902 links to the transmitter device 903 through the Proprietary Wi-Fi (P Wi-Fi) protocol, the transmitter device 903 acts as a work station and the transmitter device 902 acts as an access point.

In FIG. 9C, the transmitter device 901 operates in a multi-station mode. The transmitter device 901 links to the receiver device 92 through the standard Wi-Fi protocol, the transmitter device 901 acts as a work station and the receiver device 92 acts as an access point. The transmitter device 901 links to the transmitter device 902 through the Proprietary Wi-Fi (P Wi-Fi) protocol, the transmitter device 901 acts as a work station and the transmitter device 902 acts as an access point. The transmitter device 902 links to the transmitter device 903 through the Proprietary Wi-Fi (P Wi-Fi) protocol, the transmitter device 903 acts as a work station and the transmitter device 902 acts as an access point.

Based on the above, compared with the prior art, the present disclosure can make the transmitter device act as the work station of the receiver device and the wireless network router at the same time or in a time-sharing manner, and that is, the transmitter device can operate in the multi-station mode. Therefore, compared with In the prior art, each transmitter device in WLAN can link to the receiver device and the wireless network router which act as the access point devices at the same time, and send data to the receiver device and the wireless network router. Since the receiver device can be shared by multiple transmitter devices, there is no need to add an additional receiver device, which can reduce the construction cost.

The above-mentioned descriptions represent merely the exemplary embodiments of the present disclosure, without any intention to limit the scope of the present disclosure thereto. Various equivalent changes, alternations or modifications based on the claims of present disclosure are all consequently viewed as being embraced by the scope of the present disclosure.

1. A wireless device having a multi-station mode which acts as a client/station, comprising:
at least one wireless communication transceiver circuit, making the wireless device operate in the multi-station mode to simultaneously link to a plurality of access point devices of hosts/access points (APs), wherein the wireless device acts as a work station of the access point devices.

2. The wireless device according to claim 1, wherein a first device of the access point devices is a receiver device and a second device of the access point devices is a wireless network router.

3. The wireless device according to claim 1, wherein the access point devices are wireless network routers.

4. The wireless device according to claim 1, wherein the wireless communication transceiver circuit makes the wireless device act as the work station at the same time or in a time-sharing manner via multicasting, broadcasting, time division multiplexing, frequency band division multiplexing and/or orthogonal coding.

5. The wireless device according to claim 1, wherein the wireless device and one of the access point devices communicate with each other through a Wi-Fi connection, and the wireless device and another one of the access point devices communicate with each other through a proprietary Wi-Fi connection.

6. The wireless device according to claim 5, wherein the number of the at least one wireless communication transceiver circuit is one.

7. The wireless device according to claim 2, wherein the wireless device is an image surveillance device; and wherein the image surveillance device further comprises:
an image sensor, used to capture a sensing result data.

8. A wireless communication system, comprising:
at least one wireless device, wherein the wireless device has a multi-station mode and acts as a client/station; and
a plurality of access point devices acting as a plurality of hosts/access points (APs);
wherein each wireless device comprises:
at least one wireless communication transceiver circuit, making the wireless device operate in the multi-station mode to simultaneously link to a plurality of access point devices of hosts/APs, wherein the wireless device acts as a work station of the access point devices.

9. The wireless communication system according to claim 8, wherein one of the access point devices is simultaneously link to a plurality of wireless devices.

10. The wireless communication system according to claim 8, wherein a first device of the access point devices is a receiver device and a second device of the access point device is a wireless network router.

11. The wireless communication system according to claim 8, wherein the access point devices are wireless network routers.

12. The wireless communication system according to claim 8, wherein the wireless communication transceiver circuit makes the wireless device act as the work station at the same time or in a time-sharing manner via multicasting, broadcasting, time division multiplexing, frequency band division multiplexing and/or orthogonal coding.

13. The wireless communication system according to claim 8, wherein one of the wireless devices and one of the access point devices are linked to each other by using a Wi-Fi protocol, and said one of the wireless devices and another one of the access point devices are linked to each other by using a proprietary Wi-Fi protocol.

14. The wireless communication system according to claim 13, wherein another one of the wireless devices and said another one of the access point devices are linked to each other by using a proprietary Wi-Fi protocol.

15. The wireless communication system according to claim 8, further comprising:
a remote electronic device, used to obtain a data transmitted by the wireless device via linking to the access point devices.

16. The wireless communication system according to claim 10, wherein the wireless device is an image surveillance device and wherein the image surveillance device further comprises an image sensor which is used to capture a sensing result data.

17. The wireless communication system according to claim 15, wherein the remote electronic device is a smart phone, a tablet, a notebook or a desktop computer; and wherein the remote electronic device links to the access point devices via Wi-Fi, Wi-Max, 4G or 5G.

18. A wireless communication system, comprising:
a first wireless device;
a receiver device; and
a second wireless device;
wherein the first wireless device comprises a wireless communication transceiver circuit; and
wherein the first wireless device and the receiver device are linked to each other by using a Wi-Fi protocol, and the first wireless device and the second wireless device are linked to each other by using a proprietary RF protocol simultaneously.

19. The wireless communication system according to claim 18, further comprising:
a third wireless device comprising a wireless communication transceiver circuit;
wherein the third wireless device and the first wireless device are linked to each other by using a Wi-Fi protocol or a proprietary RF protocol, and the first wireless device acts as an access point device.

20. The wireless communication system according to claim 18, further comprising:
a third wireless device comprising a wireless communication transceiver circuit;
wherein the third wireless device and the second wireless device are linked to each other by using a proprietary RF protocol, and the second wireless device acts as an access point device; and
wherein the first wireless device acts as an access point device of the receiver device.
